(19) United States
(12) Patent Application Publication
(10) Pub. No.: US 2006/0042101 A1
(43) Pub. Date: Mar. 2, 2006

(54) Lid puncturing opener

(76) Inventor: Paul H. Roefs, Whittier, CA (US)

Correspondence Address: FULBRIGHT AND JAWORSKI LLP, 555 S. FLOWER STREET, 41ST FLOOR, LOS ANGELES, CA, 90071, US

(21) Appl. No.: 10/931,692

(22) Filed: Aug. 31, 2004

(51) Int. Cl. B26F 1/00

(52) U.S. Cl. 30/366

(57) ABSTRACT

A device for puncturing the lid of a vacuum sealed container to release the vacuum. A handle has a top surface against which pressure may be exerted by the palm or thumb of the user. A sharp point extends from the bottom surface of the handle, the point being formed to penetrate the lid when pressure is exerted against the top surface of the handle, the length of the shank being such as to extend less than 3/8 inch from the bottom end of the handle, preferably less than 1/8 inch, most preferably less than 1/16 inch. In preferred embodiments, the handle has an integral lower portion of substantially cylindrical shape axially central of the handle, formed to accommodate a user's index and middle fingers when the user's thumb contacts the top surface of the handle. An axial shank has a proximal end secured in the lower handle portion, the distal end of the shank defining the sharp point extending from the lowermost surface of the handle. A layer of compressible material can be disposed on the bottom of the handle, the shank point extending through the compressible material.

### BACKGROUND

1. Field of the Invention

The field of the invention generally relates to kitchen utensils, and specifically to devices for relieving the vacuum seal of lidded containers.

2. Related Art

To avoid contamination and prevent tampering, many food and beverage, and medicine containers available in the marketplace are equipped with vacuumed sealed lids, wherein the food or liquid is place in the container while hot and allowed to cool after the lid is screwed or pressed onto the container to securely seal the container. The resultant vacuum forces are often quite large and require a disengagement force that is difficult to generate by normal human hand and wrist action. Even a hardy person must sometimes resort to extraordinary effort to remove the lid. The difficulty is exacerbated for the elderly and/or physically challenged.

A number of devices have been offered or suggested to aid in removing such lids, to remove other strongly secured lids, such as paint can lids, or to otherwise open sealed containers. Lid wrenches and other devices to provide mechanical leverage to help turn a lid against the force of a vacuum seal are illustrated by U.S. Pat. Nos. 3,724,296 (Graver), 5,083,482 (Floyd), 6,105,468 (Fohrman et al.), D440,842 (Vandergaw), and 6,490,951 (Davidson). Such devices, while providing leverage still require substantial strength to use and are large and relatively expensive. Devices that have been designed for prying open paint cans and the like, and to also punch a hole in the paint can gutter to enable paint to drain back into the can, are illustrated by U.S. Pat. Nos. 4,580,302 (Barth), 5,127,121 (Bossie), 5,568,665 (Fick), and 6,360,444 (Fluhr et al.). Such devices take advantage of a space between the edge of the paint can and the lid, where a gutter is formed, and are not useful for removing vacuum sealed lids, which generally do not have such a pry edge. Devices that have been designed to puncture can tops or to facilitate or replace the use of built-in tab openers are illustrated by U.S. Pat. Nos. 4,357,753 (Wilkinson), 4,136,448 (Fournier et al.), 4,549,451 (Widman), 5,203,087 (Richard), and 5,644,848 (Totten). Such devices are large and relatively expensive, are not readily applied to vacuum sealed jar lids or the like. Moreover, the holes punched into the can tops are generally too large to be easily resealed if that is desired by the consumer. U.S. Pat. No. 5,150,802 (Jeffers) describes a puncture and seal apparatus that can be secured to a container, which straddles the container, a presser plate pushing the bottom of the can onto a piercing cone which creates a pierced opening and then seals the opening for subsequent use as a spout that can be opened and closed. Aside from its relatively high cost and great size, the device is not useful to open vacuum sealed lids on jars and the like. Finally, of superficial relevance to the structure of the present invention, is a golf tee awl for making holes in the ground, to make it easier to insert golf tees, is disclosed in U.S. Pat. No. 4,090,298 (Rushforth). There is no suggestion that such a device could be used to release the vacuum of sealed jar lids and the like, nor could the elongate spike of that device be easily used for that purpose.

### SUMMARY

The present invention solves the problem of hard-to-remove lids from jars and other containers and overcomes the drawbacks of the prior art. The device of the present invention enables even a weak, disabled or very elderly person to make a tiny puncture through the lid of the container, releasing the vacuum to equalize the pressure to atmosphere so that the lid can then be removed with very little effort. If the product is to be reused, it can be placed in a refrigerator, the tiny hole providing little opportunity for spoilage. Alternatively, a small piece of tape, such as Scotch brand cellophane tape or “Magic” tape, or a small amount of wax, can be place over the tiny hole to reestablish the integrity of the lid.

More particularly, a device is provided for puncturing the lid of a vacuum sealed container to release the vacuum, having a handle that can be held in the hand of a user and having a palm or thumb contacting top surface against which pressure may be exerted by the palm or thumb of the user. A sharp point extends from the bottom surface of the handle, the point being formed to penetrate the lid when pressure is exerted against the top surface of the handle. The length of the point is such as to extend less than 3/16 inch from the bottom end of the handle, in preferred embodiments, less than ⅛ inch from the handle bottom end, and in still more preferred embodiments, less than 1/16 inch from the handle bottom end.

In particular embodiments, the point is defined by an axial shank connected at a proximal end to the handle and formed with the sharp point at its distal end, the handle being formed with a hole for receiving the proximal end of the shank secured therein. A layer of compressible material can be disposed on the bottom surface of the handle, the point extending through the compressible material when the compressible material is compressed and extending less than ⅛ inch beyond the layer of compressible material when the compressible material is uncompressed.

In other particular embodiments, the handle is formed of an upper portion defining the palm or thumb contacting surface, and an integral bottom portion of substantially cylindrical shape, sized to accommodate a user's index and middle fingers when the user's thumb contacts the top surface of the handle. The handle and point can be formed in one piece of metal, or they can be formed of different material. For example, the point can be formed of stainless steel and the handle formed of a ceramic, other metal, plastic, or of hardwood.

### BRIEF DESCRIPTION OF DRAWINGS

FIG. 1 is an elevational view of one form of device constructed in accordance with this invention;

FIG. 2 is an elevational view of another form of device constructed in accordance with this invention;

FIG. 3 is a top, plan view of the embodiment of FIG. 1;

FIG. 4 is a top, plan view of the embodiment of FIG. 2;

FIG. 5 is a bottom view of the embodiment of FIG. 1;

FIG. 6 is a bottom view of the embodiment of FIG. 2;

FIG. 7 is an elevational view of the embodiment of FIG. 1 with a layer of compressible material attached to the bottom of the device;

FIG. 8 is an elevational view of the embodiment of FIG. 2 with a layer of compressible material attached to the bottom of the device;

FIG. 9 is a partially cross-sectional view of the device of FIG. 1;

FIG. 10 is a partially cross-sectional view of the device of FIG. 2;

FIG. 11 is a partially cross-sectional view of the device of FIG. 7;

FIG. 12 is a partially cross-sectional view of the device of FIG. 8; and

FIG. 13 is an elevational view, on its side, of the pointed shank of FIGS. 9-12.

### DETAILED DESCRIPTION OF THE INVENTION

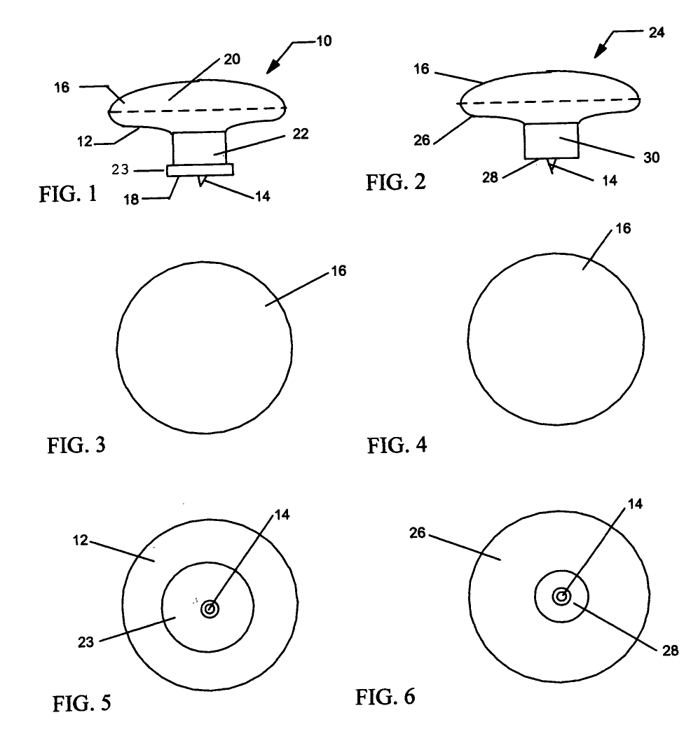

Referring to FIG. 1, one embodiment of a lid puncturing device 10 of this invention is shown, which in this embodiment comprises a handle 12 and a sharp point 14. The handle 12 is formed to be held in the hand of a user and has a smooth, circular convex top surface 16 against which pressure may be exerted by the palm or thumb of the user. The sharp point 14 extends from the bottom surface 18 of the handle 12, the point 14 being formed to penetrate the lid when pressure is exerted against the top surface of the handle. The length of the point 14 is such as to extend less than 3/16 inch, preferably less than ⅛ inch from the bottom surface 18 of the handle 12. In a more preferred embodiment, the point extends less than 1/16 inch from the handle bottom surface 18. In the embodiment of FIG. 1, the handle 12 is formed of an upper portion 20 defining the palm or thumb contacting surface 16, and an integral bottom portion 22 of substantially cylindrical shape, sized to accommodate a user's index and middle fingers when the user's thumb contacts the top surface of the handle. A flat disk-like section 23 extends by a small amount the width of the bottom portion 22 of the handle.

Referring to FIG. 2, another embodiment 24 is shown, which can be identical in all aspects as the embodiment of FIG. 1 except for its shape. Accordingly, for ease and consistency of description, when appropriate, the same lead line numbers will be used in FIG. 2 as used in FIG. 1. The embodiment of FIG. 2 also comprises a handle 26 and a sharp point 14. The handle 26 is also formed to be held in the hand of a user and has a smooth, circular convex top surface 16 against which pressure may be exerted by the palm or thumb of the user. The sharp point 14 extends from the bottom surface 28 of the handle 26. Here, too, the length of the point 14 is such as to extend less than 3/16 inch from the bottom surface 28, preferably less than ⅛ inch from the handle bottom surface 18, most preferably, 1/16 inch from the handle bottom surface. In the embodiment of FIG. 2, the handle 26 is also formed of an upper portion defining the palm or thumb contacting surface 16, and the integral bottom portion 30 is of substantially cylindrical shape, sized to accommodate a user's index and middle fingers when the user's thumb contacts the top surface of the handle. The embodiment of FIG. 2 lacks the disk like extension (23 in FIG. 1).

FIGS. 3 and 4 show top plan views of the respective devices 10 and 24. FIGS. 5 and 6 show bottom views of the respective devices 10 and 24.

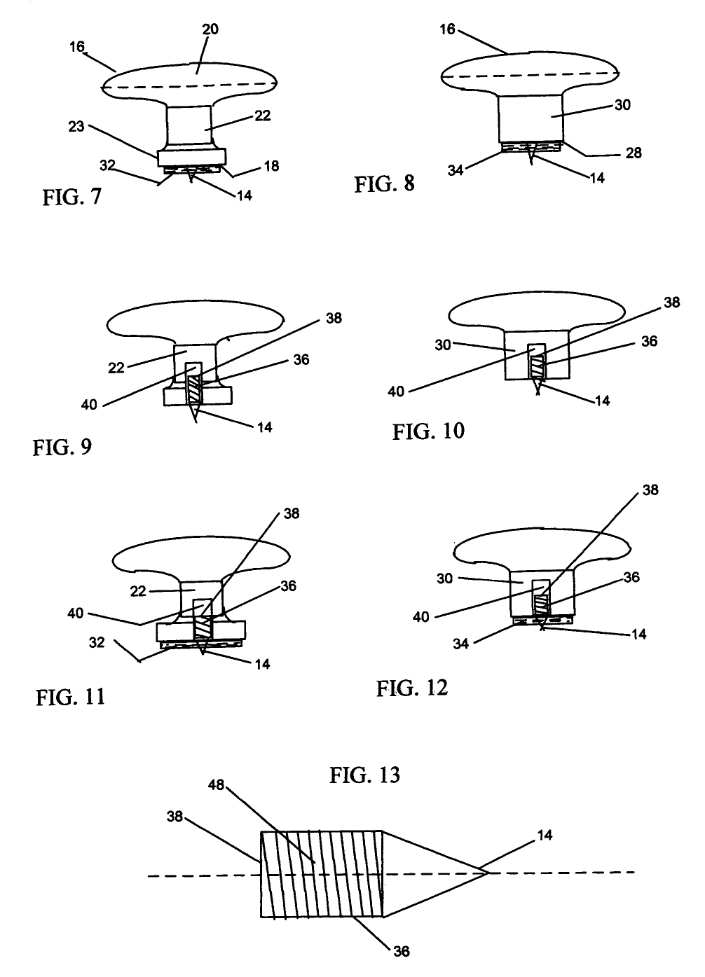

Referring to FIGS. 7 and 8, preferred embodiments are shown wherein the respective devices of FIGS. 1 and 2 are each fitted with a layer, respectively 32 and 34, of compressible material. The compressible material can be in the form of a rubber or rubber-like washer, or, more preferably, a disk of felt or similar material. The point 14 extends through the compressible material when the compressible material is compressed and extends less than 1/16 inch beyond the layer of compressible material when the compressible material is uncompressed.

Referring to FIGS. 9, 10, 11, and 12, In particular embodiments, the point 14 is defined by an axial shank or punch 36 connected at its proximal end 38 to the handle and formed with the sharp point 14 at its distal end. The handle is formed with a hole 40 for receiving the proximal end 38 of the shank 36, which is secured therein. The hole 40 and shank 36 are preferably formed with respective mating internal and external screw threads so that the shank can be screwed into the handle (and easily replaced if needed). Alternatively, the shank 36 can be pressure fit into the hole 40 or secured by use of an adhesive, such as Locktite B (Eastman 9-10), secured by plastic injection molding, or the like.

Details of the shank 36 and point 14 are shown in FIG. 13. In a specific embodiment, the shank has a length of 0.325 inch from its proximal end 38 to the tip of its sharp point 14 and has a diameter of 0.164 inch along that length. The shank 36 is formed to a cylindrical section 46, which then forms the conical point 14. The conical point forms an angle of 70 degrees from a line normal to the axial direction of the shank. As mentioned above, the shank 36 can be formed with an external screw thread that mates with a mating internal screw thread in the handle hole 40. When the handle is formed by plastic injection molding, no thread is required, the shank 36 then requiring a medium knurl for retention. However, by using a threaded shank, one obtains the added advantage of being able to adjust the extent of protrusion from the handle bottom end if needed.

The handle and shank can be formed of the same or different materials. For example, the handle can be formed of ceramic material, or other material, or both the shank and handle can be formed of stainless steel or other metal. Preferably the handle is formed of a ceramic material, or of hardwood or plastic, and the shank is formed of stainless or other steel, preferably heat-treated. In an alternative embodiment, the handle and point are formed in one piece from plastic or steel, or other metal.

1. A device for puncturing the lid of a vacuum sealed container to release the vacuum, comprising:
a handle to be held in the hand of a user and having a palm or thumb contacting top surface against which pressure may be exerted by the palm or thumb of the user; and
a sharp point extending from the bottom surface of the handle, the point being formed to penetrate the lid when pressure is exerted against the top surface of the handle, the length of the point being such as to extend less than ⅜ inch from the bottom end of the handle.

2. The device of claim 1 wherein the length of the point is such as to extend less than ⅛ inch from the bottom end of the handle.

3. The device of claim 1 wherein the length of the point is such as to extend less than 1/16 inch from the bottom end of the handle.

4. The device of claim 1 comprising a shank connected at a proximal end to the handle and formed with said sharp point at its distal end.

5. The device of claim 4 in which the handle is formed with a hole for receiving the proximal end of the shank secured therein.

6. The device of claim 1 in which the length of the point is such that it extends less than 3/16 inch from the bottom surface of the handle.

7. The device of claim 6 in which the hole and shank have respective mating internal and external screw threads.

8. The device of claim 1 in which the point is located axially central of the handle

9. The device of claim 1 including a layer of compressible material on the bottom surface of the handle.

10. The device of claim 9 wherein the point extends through the compressible material when the compressible material is compressed and extends less than ⅛ inch beyond the layer of compressible material when the compressible material is uncompressed.

11. The device of claim 1 wherein the handle is formed of an upper portion defining the palm or thumb contacting surface and an integral bottom portion of substantially cylindrical shape.

12. The device of claim 11 wherein the integral bottom portion of the handle is formed to accommodate a user's index and middle fingers when the user's thumb contacts the top surface of the handle.

13. The device of claim 1 wherein the handle and point are formed in one piece.

14. The device of claim 13 wherein the handle and point are formed in one piece of plastic material.

15. The device of claim 1 wherein the handle and point are formed of different material.

16. The device of claim 15 wherein the point is formed of stainless steel and the handle is formed of a ceramic.

17. The device of claim 15 wherein the point is formed of stainless steel or heat treated steel and the handle is formed of hardwood.

18. A device for puncturing the lid of a vacuum sealed container to release the vacuum, comprising:
a handle to be held in the hand of the user, formed of a thumb contacting top surface against which pressure may be exerted by the thumb of the user, and an integral lower portion of substantially cylindrical shape axially central of the handle, the lower handle portion being formed to accommodate a user's index and middle fingers when the user's thumb contacts the top surface of the handle;
an axial shank having a proximal end secured in the lower handle portion, the distal end of the shank having a sharp point extending from the lowermost surface of the handle and formed to penetrate the lid when pressure is exerted against the top surface of the handle; and
a layer of compressible material on the second end of the handle;
the length of the shank being such that its point extends through the compressible material when the compressible material is compressed and extends less than 1/16 inch beyond the layer of compressible material when the compressible material is uncompressed.

19. The device of claim 18 in which the hole and shank have respective mating internal and external screw threads.

20. The device of claim 18 wherein the handle and shank are formed of different material.

21. The device of claim 20 wherein the shank is formed of stainless steel or heat treated steel and the handle is formed of a ceramic.

22. The device of claim 20 wherein the shank is formed of stainless steel or heat treated steel and the handle is formed of hardwood.
